(19) United States
(12) Patent Application Publication
(10) Pub. No.: US 2010/0098443 A1
(43) Pub. Date: Apr. 22, 2010

(54) IMAGE FORMING APPARATUS AND METHOD

(75) Inventor: Hiroyuki Oka, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/581,472

(22) Filed: Oct. 19, 2009

(30) Foreign Application Priority Data
Oct. 21, 2008 (JP) 2008-270993

(51) Int. Cl. G03G 15/01; G06F 15/00

(52) U.S. Cl. 399/39; 358/1.9

(57) ABSTRACT

An image forming apparatus is provided, which forms an image by causing color material to adhere onto a print medium. The apparatus comprises a measurement component configured to measure an output density gradation characteristic of the apparatus, and a calculation component configured to calculate a color material consumption according to a dot pattern of a halftone image and the output density gradation characteristic.

### BACKGROUND OF THE INVENTION

1. Field of the Invention

The present invention relates to a technique for predicting an amount of color material to be consumed from a supplied image signal in an image forming apparatus forming an image on a print medium by causing the color material to adhere to the medium according to the image signal.

2. Description of the Related Art

An electrophotographic image forming apparatus forms an image by developing and fixing a toner onto a paper medium according to a provided image signal. For this electrophotographic developer, there is generally used a two-component developer which mainly contains a toner particle and a carrier particle (magnetic particle). By the image formation, only the toner particles are consumed within a developing device and a density of the toner particles is reduced against the carrier particles. Since the toner density is required to be constant for maintaining image quality, it is necessary to supply the toner particles to the developing device as needed according to the reduced amount of the toner particles.

As means for measuring the reduced toner particle amount, a magnetic permeability sensor is widely used. The magnetic permeability sensor detects the toner particle reduction by detecting the change of the magnetic permeability utilizing the property that the magnetic permeability is increased as the toner particles are reduced. However, since the magnetic permeability sensor is expensive, there has been developed means for calculating the reduced toner particle amount without using the magnetic permeability sensor.

As an example, there is a technique predicting the toner consumption of the image from a multi-value image signal supplied to the electrophotographic apparatus. A relationship between the multi-value image signal and the toner consumption is preliminarily examined and the total sum of the toner consumption in each pixel is obtained using the relationship, and thereby the toner consumption for the whole image signal can be calculated. Note that, since this technique needs the multi-value image signal, there has been a problem that this technique cannot accommodate the case that a halftone image signal representing a dot distribution of the toner particles on the paper medium is supplied directly to the electrophotographic apparatus. The cases that the halftone image signal is directly supplied include ones such as the case of receiving the halftone image signal generated by a host computer, a case of receiving one bit data of FAX or the like, and a case of generating a COPY-FORGENCY-INHIBITED-PATTERN.

In order to solve the above problem, there has been proposed a technique predicting the toner consumption from the halftone image signal. For example, Japanese Patent Laid-Open No. 2005-189731 discloses a technique calculating the toner amount of a dot of interest according to the number of surrounding dots. The reasons of considering the neighboring dots are that an exposure amount for one dot is different between continuous dots and an isolated dot (refer to FIG. 19) and that an electrostatic charge amount for the dot of interest changes by a surrounding electrostatic latent image (refer to FIG. 20). By considering the influence of the surrounding dot pattern to the toner consumption as in the technique disclosed by the above Japanese patent publication, it is possible to achieve the toner consumption prediction in a high accuracy.

However, there has been a problem that the above means, which adds only the dot pattern, cannot accommodate the change of output density gradation characteristic of an engine.

For example, when the output density gradation characteristic is degraded due to temporal change in the electrophotographic apparatus, a printed matter obtained for the input halftone image signal of the same pattern has a reduced toner density compared to the printed matter before the temporal change. That is, this means that the toner consumption is reduced by the temporal change (refer to FIG. 4). If the same amount of the toner as that before the temporal change is supplied to the developing device nonetheless, this invites the situation that the toners overflow from the developing device eventually.

### SUMMARY OF THE INVENTION

An object of the present invention is to realize the toner consumption prediction in a higher accuracy by considering not only the dot pattern difference but also the difference of the output density gradation characteristic in an image forming apparatus, in a technique of predicting the toner consumption according to a halftone image.

The present invention provides an image forming apparatus which forms an image by causing color material to adhere onto a print medium. The apparatus comprises a measurement component configured to measure an output density gradation characteristic of the apparatus, and a calculation component configured to calculate a color material consumption according to a dot pattern of a halftone image and the output density gradation characteristic.

The present invention can add not only the dot pattern difference but also the variation of the output density gradation characteristic to the halftone image. Thereby, it becomes possible to calculate the toner consumption always in a high accuracy without the influence of individual difference, environmental change, and temporal change in the image forming apparatus.

In addition, the present invention can update the toner consumption according to the kind of the dot pattern if a gradation correction table is available for representing the latest output density gradation characteristic of the device. There is not caused a new procedure for a user and it is possible to suppress the degradation of usability.

Further, the present invention needs not output a dedicated chart for updating the toner consumption according to the kind of the dot pattern and thereby can suppress increase of paper medium consumption.

Further features of the present invention will become apparent from the following description of exemplary embodiments (with reference to the attached drawings).

### BRIEF DESCRIPTION OF THE DRAWINGS

FIG. 1 is a block diagram of a system including an image supplying apparatus and an image forming apparatus;

FIG. 2 is a block diagram showing a system configuration of an image forming apparatus;

FIG. 3 is a schematic diagram showing a configuration of an engine in an image forming apparatus;

FIG. 4 is a block diagram showing a configuration for signal processing of a main controller in a first embodiment;

FIG. 5 is diagram showing a neighboring dot pattern and a toner consumption of a center pixel;

FIG. 6 is a flowchart showing a sequence of calculating a toner consumption for a halftone image;

FIG. 7A and FIG. 7B are diagrams showing a scheme of determining a pattern for each pixel of a halftone image;

FIG. 8 is a flowchart showing a sequence of calculating a toner consumption for each neighboring dot pattern;

FIG. 9 is a diagram showing a patch image for measuring the toner amount of a dot pattern;

FIG. 10 is a diagram showing an example of graph data which is registered in a density value/toner amount conversion table;

FIG. 11 is a block diagram showing a configuration for signal processing of a main controller in a second embodiment;

FIG. 12 is a flowchart showing a sequence of calculating a density gradation correction table;

FIG. 13 is a diagram of a patch image for density gradation correction;

FIG. 14 is a diagram showing an example of a graph for an input density and a measured density value;

FIG. 15 is a diagram showing a gradation correction graph corresponding to the graph of FIG. 14;

FIG. 16 is a flowchart showing a sequence of calculating a toner consumption for each neighboring dot pattern;

FIG. 17 is an explanatory diagram for a sequence of obtaining a relational expression for a toner consumption ti of each dot pattern;

FIG. 18 is a block diagram showing a configuration for signal processing of a main controller in a third embodiment;

FIG. 19 is a diagram showing an example of a difference between an isolated dot and continuous dots; and

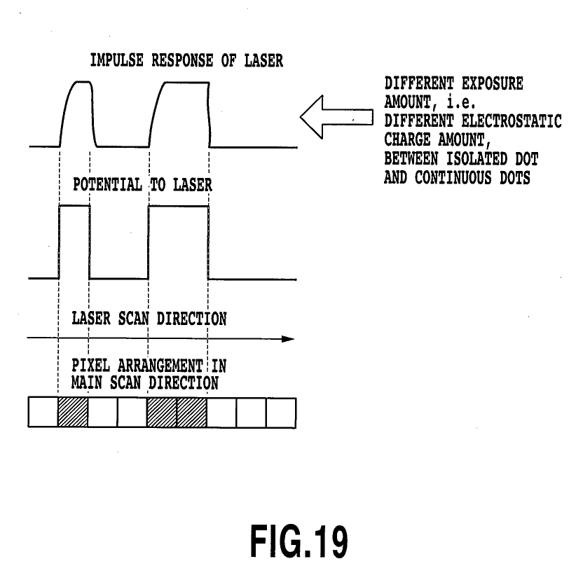

FIG. 20 is a diagram showing an example of influence of an electrostatic latent image between dots.

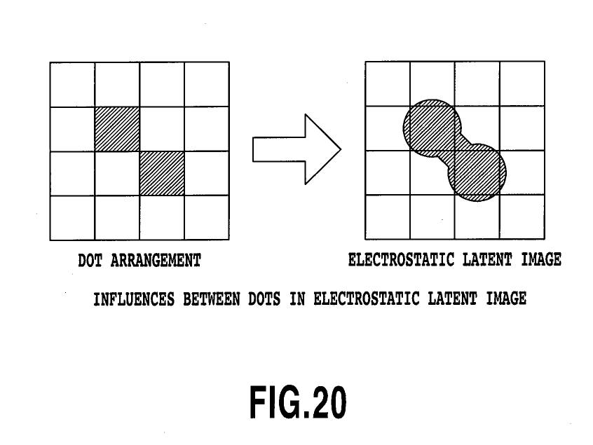

### DESCRIPTION OF THE EMBODIMENTS

Hereinafter, the best mode for implementing the present invention will be described using the drawings.

### First Embodiment

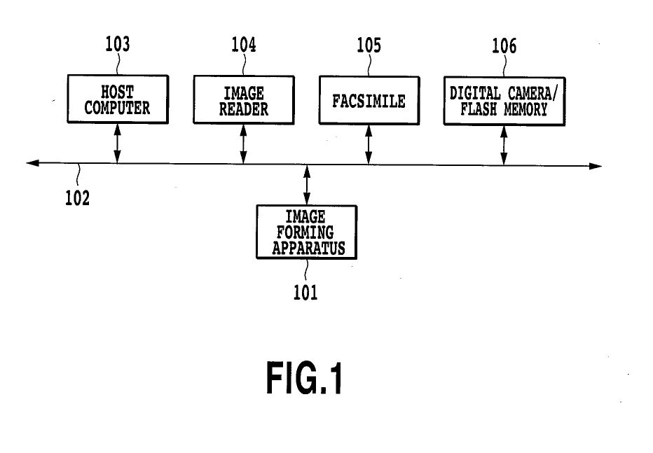

FIG. 1 is a diagram schematically showing a communication relationship between an image forming apparatus according to an embodiment of the present invention and an image supplying apparatus. An image forming apparatus 101 is connected to various kinds of image supplying apparatuses via a data transmission line 102 which represents a network transmission line, a USB cable, etc. As the image supplying apparatus, FIG. 1 shows a host computer 103, an image reader 104 represented by a CCD line scanner, a facsimile machine 105, and an image storing medium 106 such as a digital camera and a flash memory.

In the host computer 103, a printer driver converts print data which a user generates using an application into a print command and transmits the print command to the image forming apparatus 101. The image reader 104, the facsimile machine 105, and the digital camera/flash memory 106 transmit obtained image data to the image forming apparatus 101, respectively. The image reader 104 and the facsimile machine 105 may be configured to be built in the image forming apparatus 101.

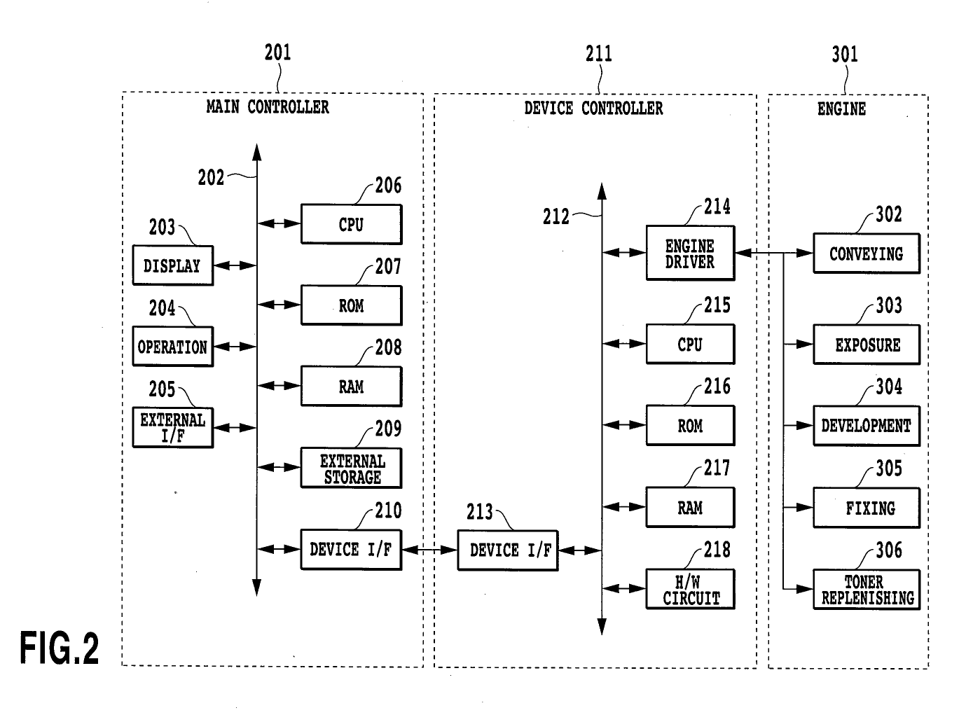

FIG. 2 is a block diagram showing a system configuration of the image forming apparatus 101.

The image forming apparatus 101 is configured with a main controller 201, a device controller 211, and an engine 301.

The main controller 201 receives an image supplied by the image supplying apparatus, carries out image processing, and outputs a halftone image of a toner image (latent image). The main controller 201 is configured to be connected with a display unit 203, an operation unit 204, an external interface 205, a CPU 206, a ROM 207, a RAM 208, an external storage device 209, and a device interface 210 via a data transmission bus 202. A user provides an operation instruction to the image forming apparatus 101 using the operation unit 204 while watching an operation screen displayed on the display unit 203.

The external interface 205 receives data sent from the host computer 103, the image reader 104, the facsimile machine 105, or the image storing medium 106 such as the digital camera and the flash memory in FIG. 1. When the operation unit 204 provides the operation instruction or the external interface 205 receives the data, the CPU 206 interprets the above command or the data according to a program written in the ROM 207. In a case that data spool is necessary, the CPU 206 carries out the image processing using the RAM 208 or the external storage device 209 and generates a halftone image signal. The CPU 206 also calculates a toner consumption (color material consumption). The halftone image signal and the toner consumption information are transmitted to the device controller 211 via the device interface 210.

The device controller 211 receives the halftone image signal and the toner consumption information from the main controller 201 and operates each device in the engine 301 according thereto. The device controller 211 is configured with a device interface 213, an engine driver 219, a CPU 215, a ROM 216, a RAM 217, and a hardware circuit (H/W circuit) 218 via a data transmission bus 212. The print data output from the main controller 201 is received by the device interface 213. The CPU 215 and the hardware circuit 218 perform necessary processing on the received data and operate each device in the engine 301 at appropriate timing via the engine driver 219.

The engine 301 mainly includes a conveying device 302, an exposure device 303, a development device 304, a fixing device 305, and a toner replenishing device 306.

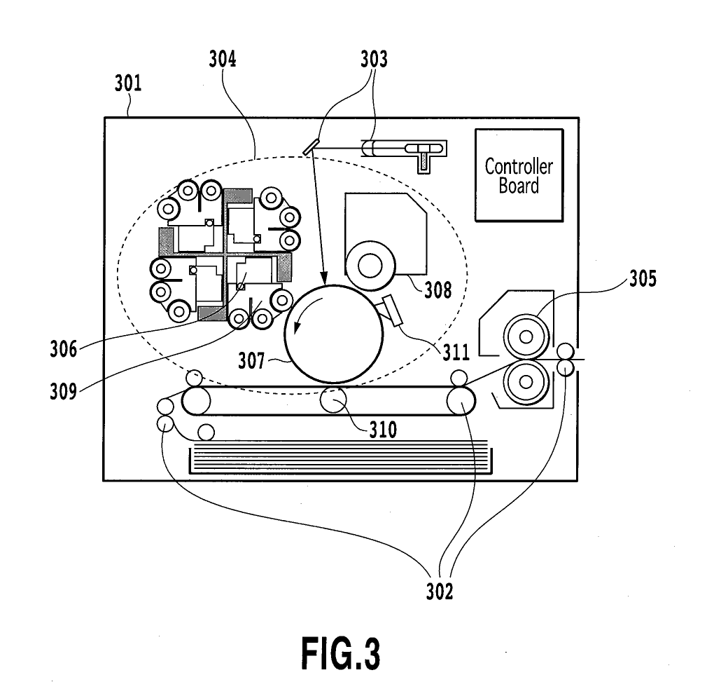

FIG. 3 is a schematic diagram showing an appearance configuration of the engine 301 in the image forming apparatus 101.

The engine 301 is configured with the conveying device 302, the exposure device 303, the development device 304, and the fixing device 305. The development device 304 is configured with the toner replenishing device 306, a photosensitive drum 307, a charger 308, a developing device 309, an image transfer device 310, and an electricity remover 311. The operation of the engine 301 will be described below.

First, the charger 308 enables a charged magnetic material to contact the photosensitive drum 307 and rotates the photosensitive drum 307 in the arrow direction, thereby providing electrostatic charge to the whole surface of the photosensitive drum 307. Next, the exposure device 303 irradiates a laser onto the photosensitive drum 307 to form an electrostatic latent image thereon. Then, the developing device 309 enables the two-component developer of the carrier and toner particles to contact the surface of the photosensitive drum 307 and thereby enables only the toner particles to adhere onto the photosensitive drum 307 according to the shape of the electrostatic latent image. Subsequently, the conveying device 302 conveys the print medium to the image transfer device 310 at appropriate timing. The image transfer device 310 provides charge having a reverse polarity to the charge polarity of the toner particles and thereby enables the toner to adhere onto the print medium. Then, the fixing device 305 fixes the toner particles at a high temperature and a high pressure to form a desired image on the print medium.

The developing device 309 needs to keep a mixture ratio of the toner particles and the carrier particles constant for stabilizing image quality. For this purpose, the toner amount used for the image forming is obtained by the below-described method and a process is carried out as needed for supplying the toner in the obtained toner amount to the developing device 309 from the toner replenishing device 306.

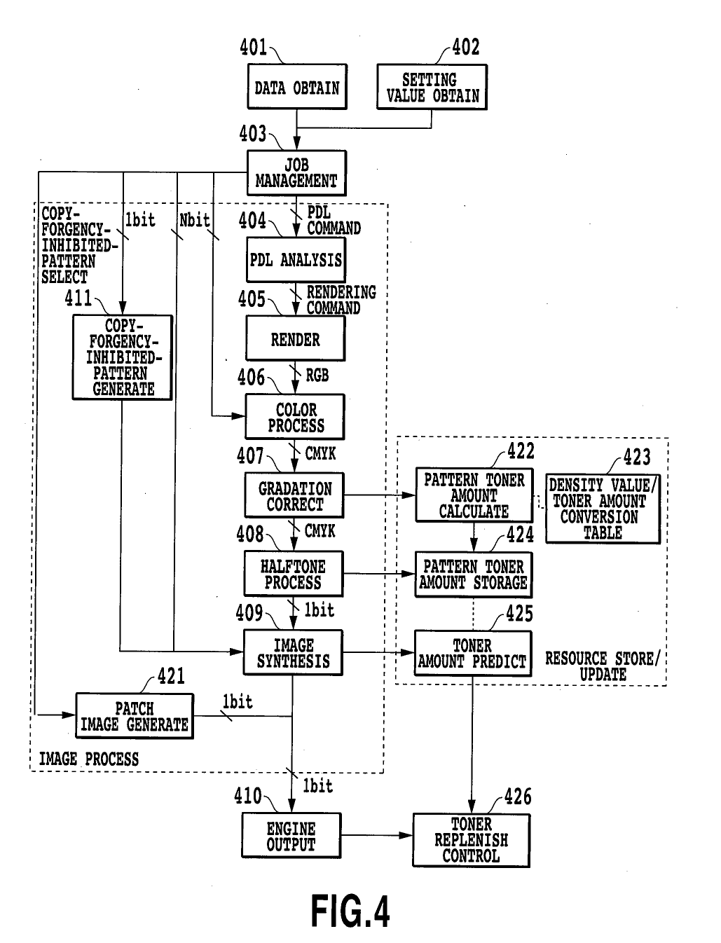

FIG. 4 is a block diagram showing a configuration of signal processing in the main controller 201.

A data obtaining part 401, after having received the print command or the image signal, outputs the received data to a job management part 403. The job management part 403 obtains a user setting on the operation screen from a setting value obtaining part 402 and selects image processing to be executed according to the received data contents and the user setting.

First, operation will be described for the case that the input data is a PDL (Print Description Language) command. The job management part 403 sends the PDL command to a PDL analysis part 404. The PDL analysis part 404 interprets the PDL command and sends a rendering command to a rendering part 405. The rendering part 405 draws a bit map image according to the rendering command and sends an RGB image to a color processing part 406. The color processing part 406 converts the RGB image into a toner density image. The density image generated in the color processing part 406 is a CMYK (Cyan Magenta Yellow Black) image which takes an eight bit value from 0 to 255 in each pixel. Obviously, another format may be used and the kind of the color material may not include CMYK but may include only K (Black). Next, a gradation correction part 407 corrects the density gradation of the density image according to the output density gradation characteristic of the engine and sends the corrected density image to a halftone processing part 408. The halftone processing part 408 converts the received density image into a PDL halftone image and sends the PDL halftone image to an image synthesis part 409.

When COPY-FORGENCY-INHIBITED-PATTERN printing is instructed in the user setting received by the job management part 403, a COPY-FORGENCY-INHIBITED-PATTERN generation part 411 generates a COPY-FORGENCY-INHIBITED-PATTERN halftone image and sends it to the image synthesis part 409. The image synthesis part 409 combines the above PDL halftone image and the above COPY-FORGENCY-INHIBITED-PATTERN halftone image to generate one halftone image.

On the other hand, when the data received by the job management part 403 is image data such as image data read by the image reader, the PDL analysis and the rendering are not necessary, and the color processing part 406 to the halftone processing part 408 carry out the image processing to generate a halftone image and send it to the image synthesis part 409. Meanwhile, when the data received by the job management part 403 is FAX data or 1-bit Tiff image, the data is already subjected to the halftone processing and the received data is directly output to the image synthesis part 409.

The final halftone image generated in the image synthesis part 409 is transferred to an engine output part 410, which outputs a printed matter in which the toner is fixed.

The halftone image is output from the image synthesis part 409 also to a toner amount prediction part 425, which calculates the toner amount to be consumed. When the toner amount prediction part 425 transmits the calculated toner amount to a toner replenish control part 426, the toner is supplied to the developing device 309 from the toner replenishing device 306 in the amount to be consumed.

A scheme of the toner consumption prediction method used in the toner amount prediction part 425 will be described here. The toner amount prediction part 925 calculates the toner consumption for each pixel of the halftone image by determining the neighboring dot pattern and obtains a sum total for all the pixels.

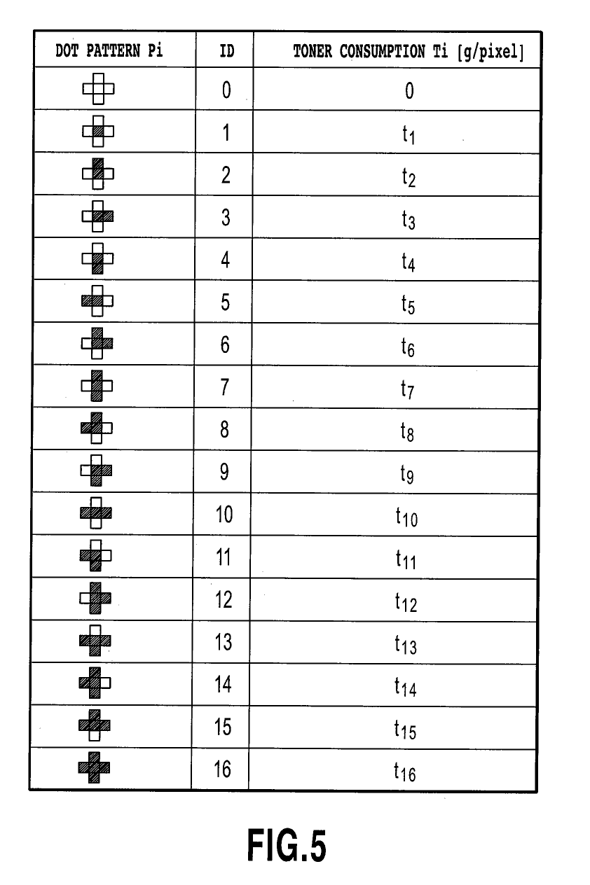

FIG. 5 shows the kinds of the neighboring dot patterns and the toner consumption of the center pixel in each of the patterns. While this figure shows 16 kinds of dot patterns in which a dot neighbors a pixel of interest on the upper, lower, left or right side, it is preferable for a higher accuracy in an actual case to prepare total 256 kinds of neighboring dot patterns including the neighboring pixels in the oblique directions. However, the present embodiment will describe an example using the 16 kinds of neighboring dot patterns for the upper, lower, left, and right sides for convenience of description. FIG. 5 shows the toner consumption ti (i=1 to 16) for each of the patterns pi (i=1 to 16). These toner consumptions ti are calculated preliminarily before the print execution. A method of calculating this toner consumption ti will be described hereinafter. A relationship between a pattern ID and the toner consumption thereof is stored in a pattern toner amount storing part 424 in a format of a look up table.

Next, there will be described a sequence in which the toner amount prediction part 425 predicts the toner consumption from the halftone image.

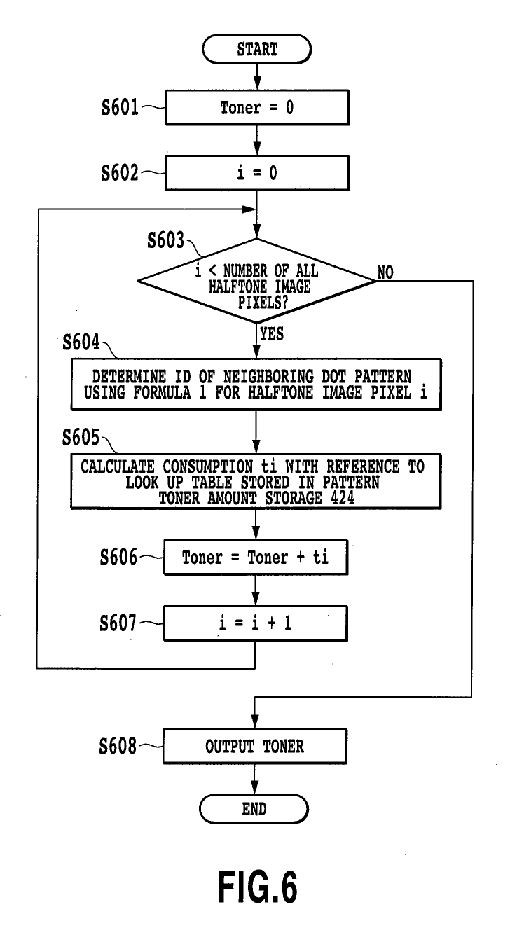

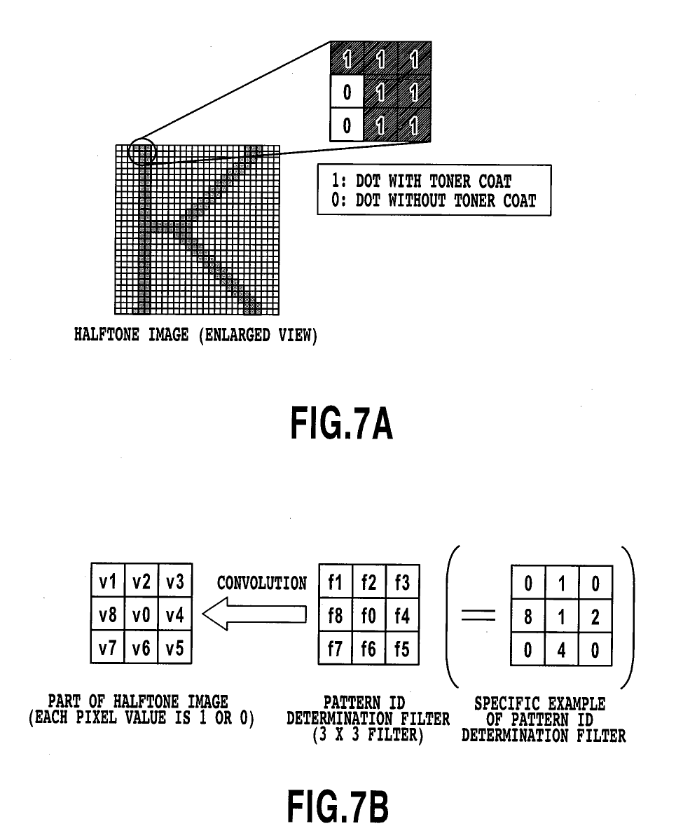

FIG. 6 shows a flowchart of a process sequence in the toner amount prediction part 425. In step S601, the toner amount prediction part 425 initializes a toner amount count Toner to zero. Further, in step S602, the toner amount prediction part 425 initializes a control variable for looping all the pixels of the halftone image (i.e. Iterator) to zero. First, in determination step S603, the toner amount prediction part 425 determines whether all the pixels have been scanned or not, and moves to step S604 if all the pixels have not been scanned. In step S604, the toner amount prediction part 425 determines ID of the neighboring dot pattern for a pixel i of the halftone image. An example of the halftone image here is an image in which one is stored for a pixel to be coated with the toner and zero is stored in a pixel not to be coated with the toner as shown in FIG. 7a. For obtaining the neighboring dot pattern ID for a certain pixel of interest, the toner amount prediction part 425 carries out a convolution computation of formula 1 using a 3×3 filter shown in FIG. 7b.

$$Pattern = {v}_{0} {f}_{0} ( 1 + {\sum }_{i = 1}^{8} {v}_{i} {f}_{i} ) \qquad ( Formula 1 )$$

The computation result of formula 1 represents the pattern ID. Subsequently, after having obtained the toner consumption for the pattern ID represented by the computation result, from the look up table in the pattern toner amount storing part 424 in step S605, the toner amount prediction part 425 adds the toner consumption to the toner amount count Toner in step S606. In S607, the control variable i is incremented and the process returns to determination step S603 for repetition. After steps S604 to S606 have been repeatedly carried out for all the pixels of the halftone image, the toner amount prediction part 425 determines NO in step S603 and moves to step S608 where the toner amount prediction part 425 outputs the value of the toner amount count Toner and terminates the process of this flowchart. When the toner amount prediction part 425 transmits the toner consumption calculated by the above processing to the toner replenish control part 426, the toner is supplied in the calculated amount to the developing device 309 from the toner replenishing device 306.

Next, a sequence of calculating a relationship between the neighboring dot pattern and the toner consumption will be described. Since the toner consumption for each of the neighboring dot patterns is affected by the variation in the output density gradation characteristic of the engine, it is preferable to update the toner consumption at the same time with the update of a gradation correction table in the gradation correction part 407.

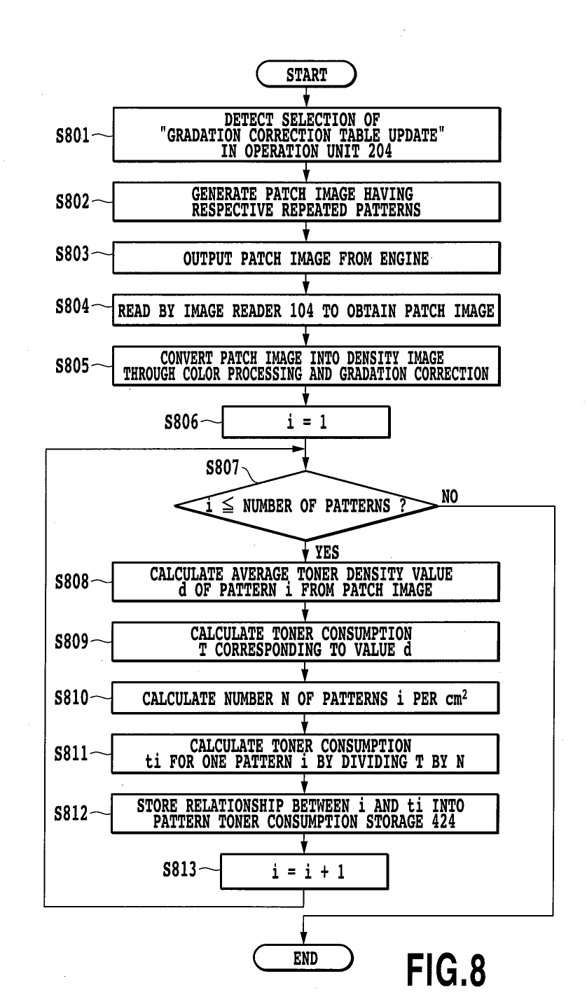

The flowchart of FIG. 8 shows a sequence of measuring the toner consumption for each of the dot patterns, the measurement being carried out together with the update processing when a user executes an order of updating the gradation correction table in the operation unit 204.

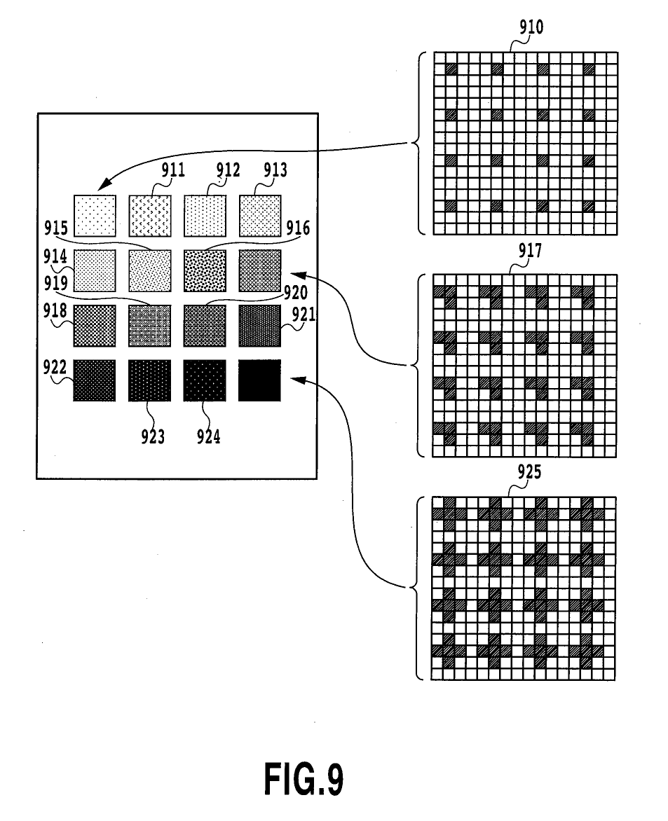

First, in step S801, the setting value obtaining part 402 notifies the job management part 403 when having detected that the user selected “gradation correction table update” in the operation unit 209, and the notified job management part 403 provides an instruction of generating a patch image to a patch image generation part 421. Next, in step S802, the patch image generation part 421 generates the patch image using each of the dot patterns shown in FIG. 5. This patch image is an image in which each of the dot patterns is repeated two-dimensionally so as to form a square large enough to allow density measurement and the respective squares 910 to 925 are laid out as shown in FIG. 9.

Next, in step S803, the patch image generation part 421 transmits the patch image to the engine output part 410, and the patch image is output from the engine output part 410. At the same time, another patch image is also output for the gradation correction table update. For feeding back the engine output density gradation characteristic and the toner consumption characteristic to the image forming apparatus 101, the user causes the image reader 104 to read each of the patch image output materials and to transmit it to the image forming apparatus 101. Next, in step S804, the data obtaining part 401 obtains the image data from the image reader 104. Subsequently, in step S805, the job management part 403 updates the gradation correction table in the gradation correction part 407, converts the patch image into a density image through the color processing part 406 and the gradation correction part 407, and transmits the patch image to a pattern toner amount calculation part 422.

The pattern toner amount calculation part 422 executes the steps S806 to S813 as follows. First, in step S806, the pattern toner amount calculation part 422 initializes a control variable for controlling the number of repetition to one. Next, in determination step S807, the pattern toner amount calculation part 422 determines whether or not the processing is repeated in the number of the neighboring dot patterns, and moves to step S808 if the processing has not been completed. In step S808, the pattern toner amount calculation part 422 calculates an average toner density value d of the pattern i from the patch image. For calculating the average toner density value d, the pattern toner amount calculation part 422 calculates the number of pixels S corresponding to an area of 1 cm² from a read resolution of the image reader 104 and obtains an average density thereof referring to the S pixels in the area of the dot pattern i of the patch image.

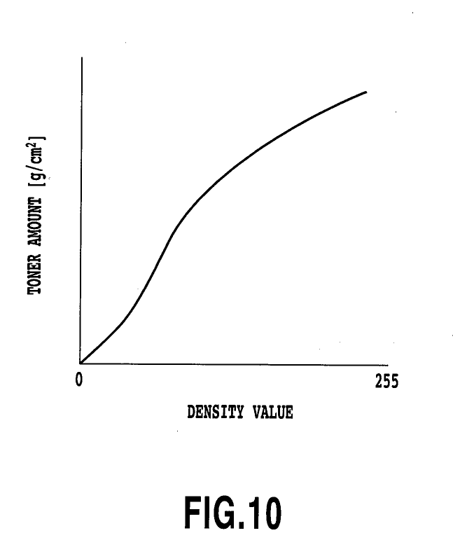

Next, in step S809, the pattern toner amount calculation part 422 obtains the toner consumption T (g/cm²) corresponding to the average toner density value d referring to a density value/toner amount conversion table 423. This density value/toner amount conversion table 423 registers the graph data exemplarily shown in FIG. 10 and shows the toner amount (g/pixel) to be consumed for a target density value (density value before the gradation correction) 0 to 255 (corresponding to 0 to 100%). This graph data is determined uniquely if the kind of the toner is determined and obtained experimentally in advance to be stored in the density value/toner amount conversion table 423.

Next, in step S810, the pattern toner amount calculation part 422 calculates the number of patterns N per cm² referring to the pixel numbers S in the area of the dot pattern i of the patch image. As shown in FIG. 9, the pattern is repeated each 4×4 pixels and the number of S divided by 16 becomes N. Then, in step S811, the pattern toner amount calculation part 422 obtains the toner consumption ti for one pattern i by dividing T by N. In step S812, the pattern toner amount calculation part 422 updates the toner consumption of FIG. 6 by transferring a relationship between the pattern ID (=i) and the toner consumption ti to the pattern toner amount storing part 424. In step S813, the pattern toner amount calculation part 422 returns to determination step S807 after having incremented i, and terminates the process when the processing has been completed for all the patterns.

The present embodiment adds not only the difference of the dot pattern but also the variation of the output density gradation characteristic to the halftone image. Thereby, it becomes possible to calculate the toner consumption always in a high accuracy without being affected by the individual difference, environmental change, and temporal change in the image forming apparatus.

### Second Embodiment

The first embodiment needs the sequence of outputting the patch image from the engine and measuring the density thereof for updating the toner consumption for each of the dot patterns. In the present embodiment, there will be described a scheme enabling the toner consumption to be updated by updating the gradation correction table without newly outputting the patch image for measurement.

While a basic system configuration of the present embodiment is the same as that of the first embodiment, a signal processing configuration of the main controller is different.

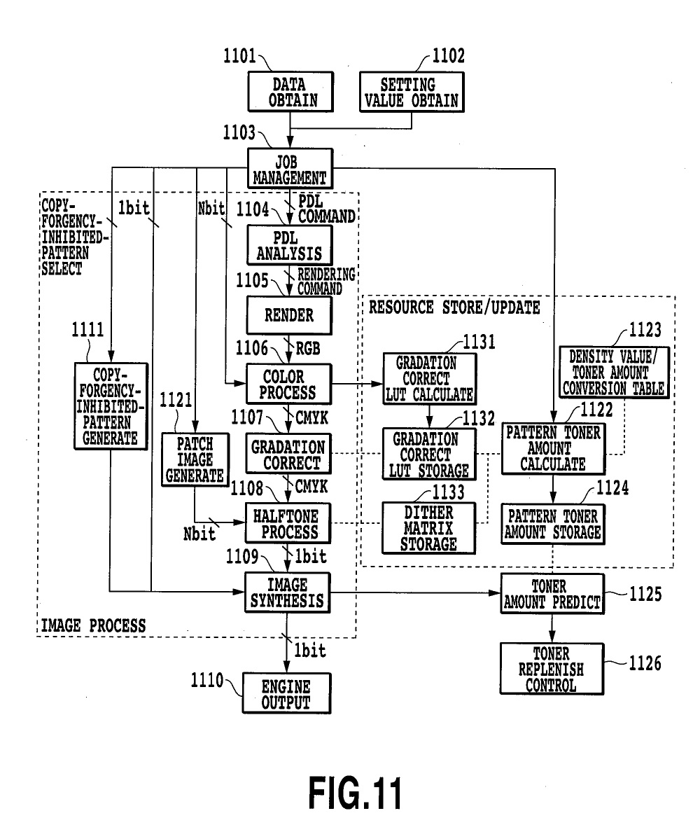

FIG. 11 is a block diagram showing the signal processing configuration of the second embodiment in the main controller 201.

The configuration is different in two points from that of the first embodiment shown in FIG. 4. One is that a gradation correction LUT calculation part 1131, a gradation correction LUT storing part 1132, and a dither matrix storing part 1133 are added, and the other one is in the processing contents of a job management part 1103, a pattern toner amount calculation part 1122, and a patch image generation part 1121. These differences come from that the scheme of the present embodiment is different from that of the first embodiment for calculating and updating the toner consumption according to the kind of the dot pattern.

First, the present embodiment outputs the density gradation patch image from the engine, measures the patch image, and updates a density gradation correction table. Then, the present embodiment calculates and updates the toner consumption according to the kind of the dot pattern using the information of the density gradation correction table, a dither matrix, and the density value/toner amount conversion table.

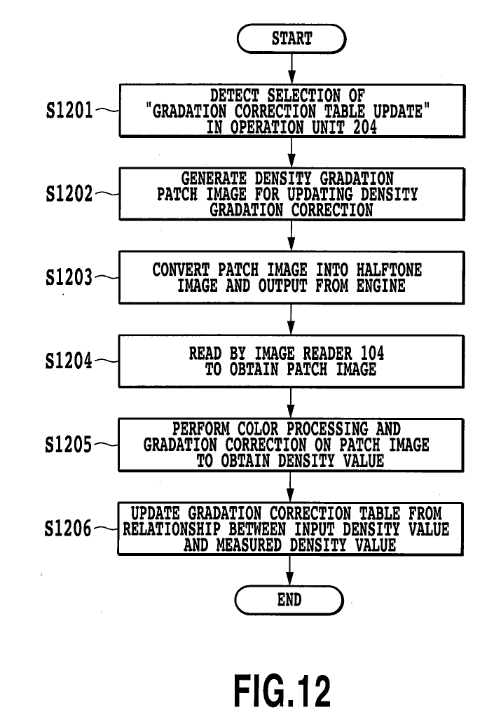

FIG. 12 shows a sequence of calculating the density gradation correction table.

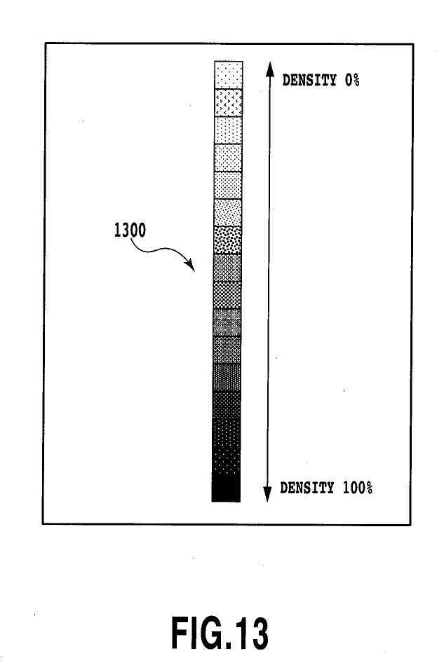

First, in step S1201, a setting value obtaining part 1102 detects that a user has selected “gradation correction table update” in the operation unit 204 and notifies the job management part 1103. The notified job management part 1103 provides an instruction of generating the patch image to the patch image generation part 1121. Next, in step S1202, the patch image generation part 1121 generates a patch image 1300 with an input density in which the density values 0 to 100% are set in a predetermined number of steps as shown in FIG. 13. Next, in step S1203, the patch image generation part 1121 sends the patch image 1300 to a halftone processing part 1108. The halftone processing part 1108, after having converted the received patch image 1300 into a halftone image, transmits it to an engine output part 1110. Thereby, the patch image is output from the engine. For feeding back the engine output density gradation characteristic to the image forming apparatus 101, the user causes the image reader 104 to read the patch image output material and to transmit it to the image forming apparatus 101.

Next, in step S1204, a data obtaining part 1101 obtains the image data from the image reader 104. In step S1205, the job management part 1103 converts the patch image into a density image through the color processing part 406 and the gradation correction part 407, and further obtains an actual density value from each density area of the density image. In step S1206, the job management part 1103 generates a table of a relationship between the input density when the patch image is generated and the actually measured density value.

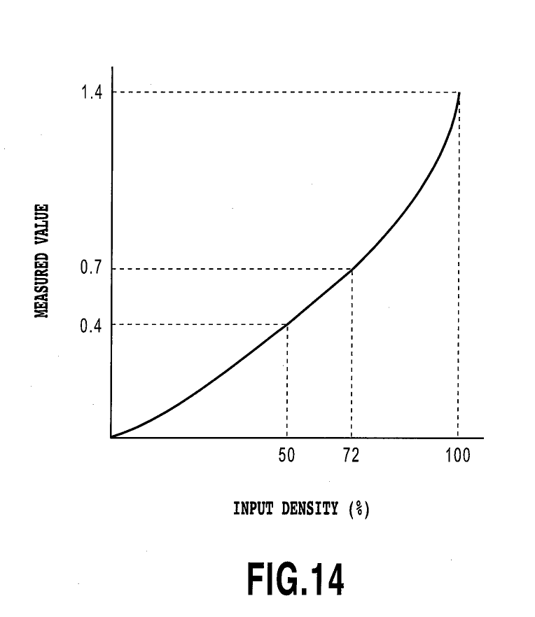

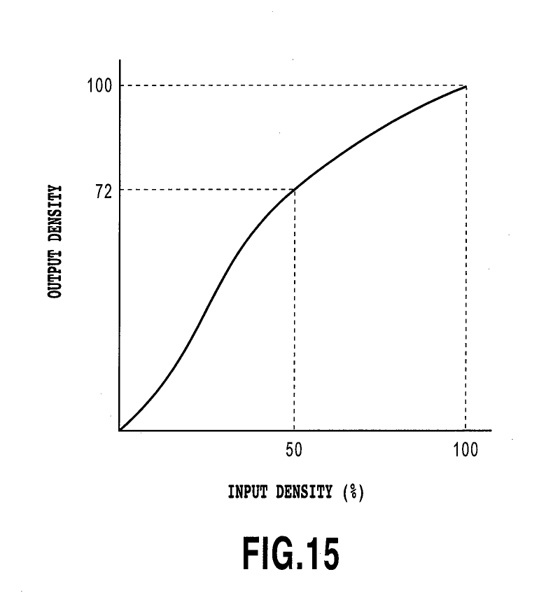

FIG. 14 shows a specific example of a graph representing this relationship. According to this graph, while the measurement value is 1.4 for the input density of 100%, for the input density of 50%, for example, the measurement value is 0.4 smaller than a half value of 0.7. Accordingly, a correction needs to be carried out so that the measurement value becomes 0.7 for the input density of 50%. For this correction, the input density causing the measurement value to be 0.7, a half of 1.4, is searched for. The graph shows that the input density of 72% is the density to be searched for. Accordingly, the gradation correction LUT calculation part 1131 generates a table correcting an output density to 72% for the input density of 50%. FIG. 15 shows an example of the density gradation correction table generated in this manner. This graph shows that the output density is corrected to 72% for the input density of 50%. The gradation correction LUT calculation part 1131 stores the density gradation correction table generated in the above sequence into the gradation correction LUT storing part 1132.

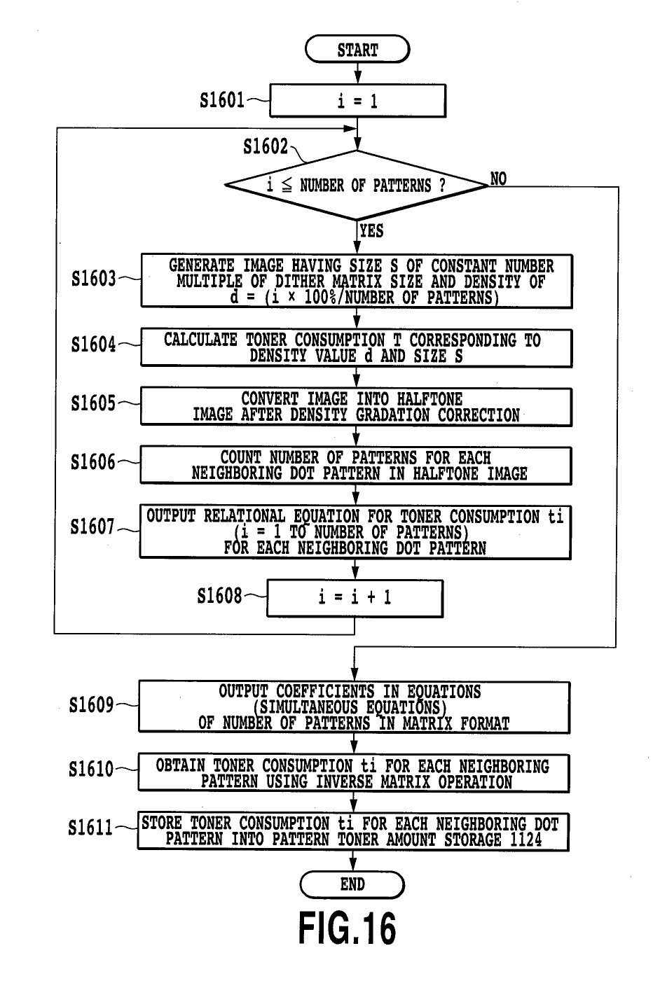

FIG. 16 is a flowchart showing a sequence of calculating the toner consumption for each of the neighboring dot patterns. In the following, the sequence will be described with reference to FIG. 16.

First, in step S1601, the pattern toner amount calculation part 1122 initializes a control variable i for repeating the processing in the number of patterns to one. Next, in determination step S1602, the pattern toner amount calculation part 1122 determines whether or not the processing is repeated in the same number of times as the number of all the patterns. If the processing has not been completed, the pattern toner amount calculation part 1122 executes the processing of steps S1603 to S1608. The series of steps S1603 to S1608 are processing outputting relational expressions for the respective dot pattern toner consumptions t1 to t16 which are unknown variables. In determination step S1602, the pattern toner amount calculation part 1122 generates 16 relational expressions for the unknown variables t1 to t16 by looping and repeating the series of steps in the same times as the number of the dot patterns.

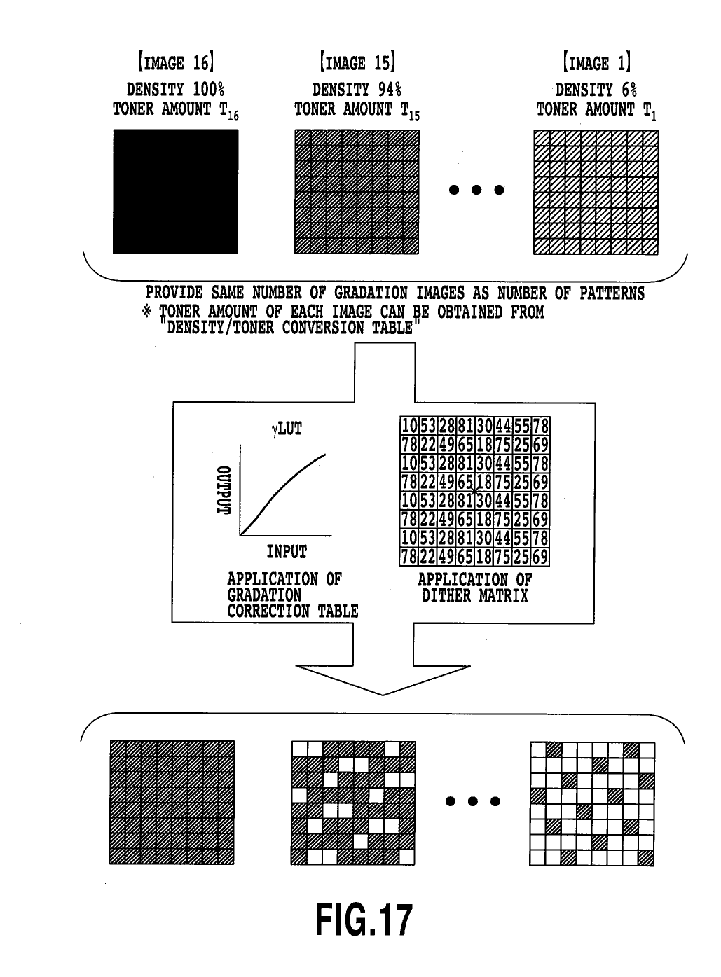

FIG. 17 is a diagram schematically illustrating this loop repetition processing. The pattern toner amount calculation part 1122 prepares gradation images which have 16 density steps from a low density of 6% to a high density of 100% (0% is not included), and converts the respective gradation images into halftone images by applying the gradation correction and the dither matrix. By counting of the number of respective patterns in each of the halftone images, a linear equation with 16 unknowns is obtained as represented by formula 2.

$$( \begin{matrix}{T}_{1} \\ {T}_{2} \\ ⋮ \\ {T}_{13}\end{matrix} ) = ( \begin{matrix}{n}_{1.1} & {n}_{1.2} & … & {n}_{1.16} \\ {n}_{2.1} & {n}_{2.2} & … & {n}_{2.16} \\ ⋮ & ⋮ & ⋱ & ⋮ \\ {n}_{16.1} & {n}_{16.2} & … & {n}_{16.16}\end{matrix} ) ( \begin{matrix}{t}_{1} \\ {t}_{2} \\ ⋮ \\ {t}_{16}\end{matrix} ) \qquad ( Formula 2 )$$

The toner consumption ti for each dot pattern can be obtained from the solution of these simultaneous equations.

Again in FIG. 16, in step S1603, the pattern toner amount calculation part 1122 generates an image having a size S of a constant number multiple of the dither matrix size and a density of d=(i×100%/number of patterns). Next, in step S1604, the pattern toner amount calculation part 1122 obtains the toner consumption T of the generated image referring to a density value/toner amount conversion table 1123. The density value/toner amount conversion table 1123 stores a conversion relationship between the target density value and the toner amount for one pixel. This relationship depends on the kind of toner and therefore can be experimentally obtained in advance if the kind of toner is fixed. Next, in step S1605, the pattern toner amount calculation part 1122 generates a halftone image by applying the density gradation correction and the dither matrix to the image. Next, in step S1606, the pattern toner amount calculation part 1122 counts the number of respective dot patterns in the halftone image and, in step S1607, outputs the relational expression for the unknown variable ti. Lastly, in step S1608, the pattern toner amount calculation part 1122 increments the variable i by one and returns to determination step S1602.

The pattern toner amount calculation part 1122 moves to step S1609 after having repeated steps S1603 to S1608 in the same times as the number of the dot patterns. In step S1609, the pattern toner amount calculation part 1122, after having represented the relational expression by the matrix operation equation as formula 2, obtains the unknown variable ti using an inverse matrix operation equation in step S1610. The pattern toner amount calculation part 1122 stores the obtained unknown variable ti into the pattern toner amount storing part 1124 in step S1611 and terminates the process.

The toner consumption of print image data input into the main controller can be calculated by completely the same sequence as that of the first embodiment.

The present embodiment can update the toner consumption according to the kind of the dot pattern if only the gradation correction table representing the latest output density characteristic of the device is available. This method does not cause a new procedure for the user and does not deteriorate the usability. Further, it is not necessary to output a dedicated chart for updating the toner consumption according to the dot pattern, and thereby it is possible to suppress the increase of the paper medium consumption.

### Third Embodiment

While the embodiment calculating the toner consumption for the halftone image is described in the first and second embodiments, in the present embodiment, there will be described an embodiment suppressing a difference in the consumption calculation results to the minimum by a combination with the conventional method which obtains the toner consumption from the multi-value density image.

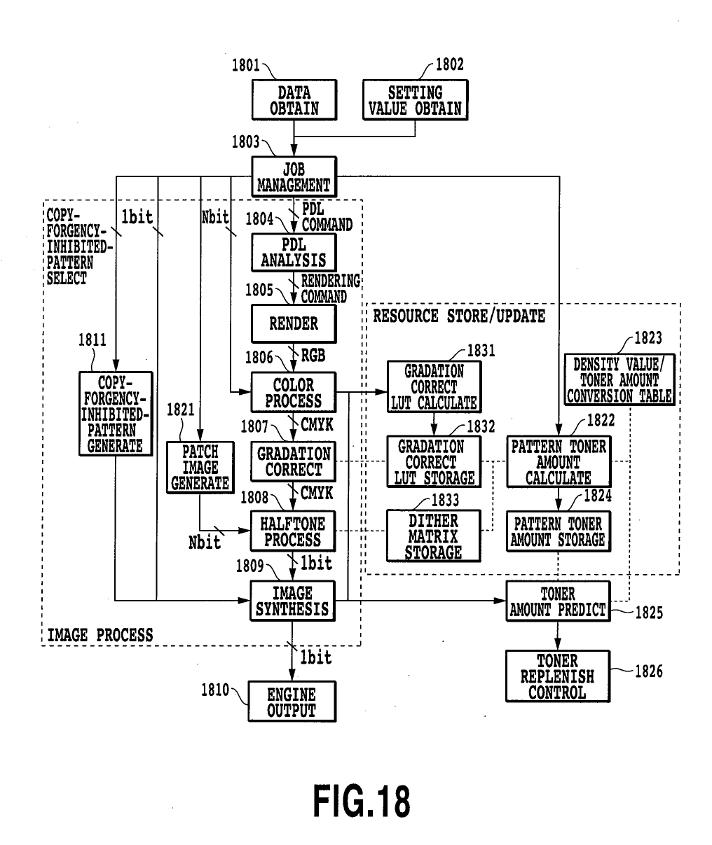

FIG. 18 is a block diagram showing a signal processing configuration of the third embodiment in the main controller 201.

The configuration (FIG. 18) of the present embodiment is different from the signal processing configuration (FIG. 11) of the first embodiment in that the image data is output from a color processing part 1806 to a toner amount prediction part 1825 and that the toner amount prediction part 1825 refers to a density value/toner amount conversion table 1823.

Typically, the image data input into a data obtaining part 1801 is frequently the multi-value gradation image. Accordingly, the toner amount prediction is carried out as in the past using the target density value through the color processing part 1806 in many cases. At this time, the toner consumption may be obtained from the target density value directly with reference to the density value/toner amount conversion table 1823. On the other hand, when the image data input into the data obtaining part 1801 is the 1-bit halftone image, the halftone image is transmitted to an image synthesis part 1809 and the toner consumption is calculated in the toner amount prediction part 1825 as in the first embodiment. Further, when generation of the halftone image such as the COPY-FORGENCY-INHIBITED-PATTERN is instructed in a setting value obtaining part 1802, only the generated background halftone image is output to the toner amount prediction part 1825 and the toner consumption is calculated as in the first embodiment.

The present embodiment can calculate the toner consumption by the combination with the conventional method calculating the toner consumption from the multi-value density image. Thereby, it is possible to suppress the difference from the conventional toner consumption prediction to the minimum.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-270993, filed Oct. 21, 2008, which is hereby incorporated by reference herein in its entirety.

What is claimed is:

1. An image forming apparatus that forms an image by causing color material to adhere onto a print medium, the apparatus comprising:
a measurement component configured to measure an output density gradation characteristic of the apparatus; and
a calculation component configured to calculate a color material consumption according to a dot pattern of a halftone image and said output density gradation characteristic.

2. The apparatus according to claim 1, wherein
said calculation component calculates said color material consumption further according to a multi-value density image.

3. The apparatus according to claim 1, wherein
said calculation component calculates a color material consumption of a dot by determining a neighboring dot pattern.

4. The apparatus according to claim 3, wherein
said calculation component calculates a color material consumption of a pixel of interest according to said neighboring dot pattern, depending on said output density gradation characteristic.

5. The apparatus according to claim 4, wherein
said calculation component obtains a density value measured in a patch image which has repeated dot patterns and is output from the apparatus, as said output density gradation characteristic.

6. The apparatus according to claim 4, wherein
said calculation component obtains density gradation values measured in gradation images which have densities from a low density to a high density, and are output from the apparatus, as said output density gradation characteristic.

7. A method of forming an image by causing color material to adhere onto a print medium, the method comprising the steps of:
measuring an output density gradation characteristic of an image forming apparatus; and
calculating a color material consumption according to a dot pattern of a halftone image and said output density gradation characteristic.

8. A computer program stored on a computer-readable medium, the program making a computer implement a method of forming an image by causing color material to adhere onto a print medium, the method comprising the steps of:
measuring an output density gradation characteristic of an image forming apparatus; and
calculating a color material consumption according to a dot pattern of a halftone image and said output density gradation characteristic.
